(19) United States
(12) Patent Application Publication
(10) Pub. No.: US 2007/0140582 A1
(43) Pub. Date: Jun. 21, 2007

(54) Systems and Methods For Reducing Noise In Image Sequences

(75) Inventors: Yunqiang Chen, Plainsboro, NJ (US); Chunxiao Zhou, Champaign, IL (US); Tong Fang, Morganville, NJ (US); Jason Jenn-Kwei Tyan, Princeton, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS CORPORATE RESEARCH INC, PRINCETON, NJ (US)

(21) Appl. No.: 11/539,212

(22) Filed: Oct. 6, 2006

Related U.S. Application Data
(60) Provisional application No. 60/727,568, filed on Oct. 17, 2005.

(51) Int. Cl. G06K 9/40

(52) U.S. Cl. 382/261

(57) ABSTRACT

A method for reducing noise in an image sequence includes: detecting structures in an image sequence; estimating lighting changes in the image sequence and compensating for the estimated lighting changes; detecting moving structures in the image sequence using the detected structures after compensating for the estimated lighting changes in the image sequence; and adaptively filtering imaging noise in the image sequence.

### CROSS-REFERENCE TO RELATED APPLICATION

This application claims the benefit of U.S. Provisional Application Ser. No. 60/727,568 (Attorney Docket No. 2005P18879US), filed Oct. 17, 2005 and entitled “Adaptive Temporal Filtering for Low-dose X-ray Sequences”, the content of which is herein incorporated by reference in its entirety.

### BACKGROUND OF THE INVENTION

1. Technical Field

The present disclosure relates to systems and methods for reducing noise in image sequences.

2. Discussion of Related Art

In recent years, medical imaging has experienced an explosive growth due to advances in imaging modalities such as X-rays, computed tomography (CT), magnetic resonance imaging (MRI), ultrasound and fluoroscopy. Fluoroscopy is an imaging technique commonly used by clinicians to obtain real-time images of the internal structures of a patient through the use of a fluoroscope. Fluoroscopic techniques can be utilized to maneuver certain instruments to diagnose and treat a patient.

While fluoroscopy is widely accepted as an anatomical guide utilized during minimally invasive and microscopic surgical procedures, as well as many types of diagnostic tests, because it involves the use of X-rays, a form of ionizing radiation, fluoroscopic procedures pose a potential health risk to the patient and staff in the X-ray room. While low dose rates are generally used during fluoroscopy procedures, the length of a typical procedure can result in a relatively high absorbed dose to the patient. Staff dose, arising from scattered radiation, due to X-ray photons scattered from the patient, objects or structures in the beam can accumulate to appreciable levels over a working year. Reduction of the dose rate used would be of benefit to the patient and staff in the X-ray room.

Dose reduction programs in fluoroscopy have been undertaken with the aim of reducing radiation dose to the staff and patients. While reducing X-ray scatter via dose reduction strategies can reduce the overall amount of scatter in the room, these methods reduce image quality. In general, the extent to which X-ray dose can be reduced is governed by the image quality required by the clinician to effectively perform a particular clinical task. It is difficult to significantly reduce the dose rate, yet retain sufficient image quality in the displayed fluoroscopic image.

### SUMMARY OF THE INVENTION

According to an exemplary embodiment of the present invention, a method is provided for reducing noise in an image sequence. The method includes: detecting structures in an image sequence, estimating lighting changes in the image sequence and compensating for the estimated lighting changes; detecting moving structures in the image sequence using the detected structures after compensating for the estimated lighting changes in the image sequence; and adaptively filtering imaging noise in the image sequence.

According to an exemplary embodiment of the present invention, a system for reducing noise in an image sequence comprises: a memory device for storing a program; a processor in communication with the memory device, the processor operative with the program to: detect structures in an image sequence; estimate lighting changes in the image sequence and compensate for the estimated lighting changes; detect moving structures in the image sequence using the detected structures after compensating for the estimated lighting changes in the image sequence; and adaptively filter imaging noise in the image sequence

According to an exemplary embodiment of the present invention, a method is provided for adaptively filtering an X-ray image sequence. The method includes detecting structures in an X-ray image sequence; detecting image differences in the X-ray image sequence using the detected structures; estimating lighting changes using the detected image differences and excluding the estimated lighting changes from the image differences; reducing noise in the image sequence by combining consecutive frames in the X-ray image sequence.

### BRIEF DESCRIPTION OF THE DRAWINGS

The present invention will become more apparent to those of ordinary skill in the art when descriptions of exemplary embodiments thereof are read with reference to the accompanying drawings.

FIG. 1 is a flowchart showing a method of reducing noise in an image sequence, according to an exemplary embodiment of the present invention.

FIG. 2 shows a block diagram illustrating a method of structure detection, according to an exemplary embodiment of the present invention.

FIG. 3 shows a block diagram illustrating a method of loose outlier detection, according to an exemplary embodiment of the present invention.

FIG. 4 shows a block diagram illustrating a method of outlier detection, according to an exemplary embodiment of the present invention.

FIG. 5 illustrates a computer system for implementing a method of reducing noise in an image sequence, according to an exemplary embodiment of the present invention.

FIG. 6 is a flowchart showing a method of adaptively filtering an X-ray image sequence, according to an exemplary embodiment of the present invention.

### DESCRIPTION OF EXEMPLARY EMBODIMENTS

Hereinafter, exemplary embodiments of the present invention will be described in detail with reference to the accompanying drawings.

In view of the motion and lighting change along the X-ray frames, the current image may be classified into two groups: static group and outlier group. For pixels in the static group, their intensity changes are mainly caused by lighting changes and noises. For pixels in the outlier group, their intensities vary with the object motion. In accordance with an exemplary embodiment of the present invention, temporal filtering is implemented for the static group and spatial filtering is conducted for outliers to reduce noise level for both of two groups.

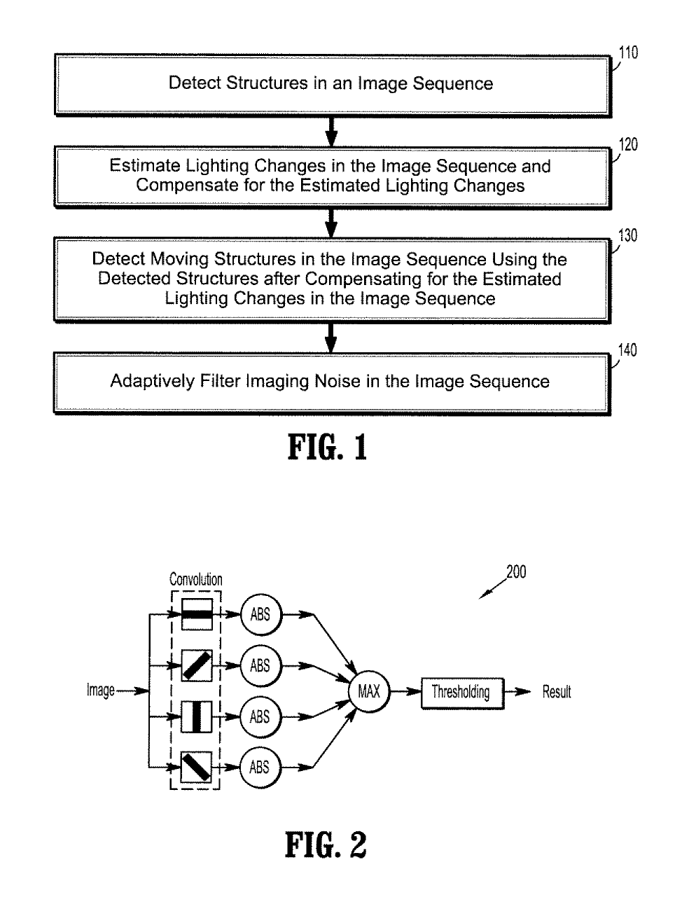

FIG. 1 is a flowchart showing a method of reducing noise in an image sequence, according to an exemplary embodiment of the present invention. Referring to FIG. 1, in step 110, detect structures in an image sequence. For example, detecting structures in the image sequence may comprise feature detection and classification.

The shape and size of objects of interest may be known, such as for example, catheters and guide wires, but not the orientations of the objects. Line-shape kernels can be applied in different orientations to convolute with the input image. To save the computation cost, four kernels in four main directions may be used, for example, when θ is equal to 0, 45, 90 and 135 degrees, respectively. Three of the four kernels may result from the rotation of the first kernel with θ=0 degrees. Bilinear interpolation may be used to obtain the values at integer coordinates. In real-time implementations, first the image pyramids may be constructed, and then the directional convolutions can be done in the coast level, which may reduce the computation cost.

After directional convolution operations, take the absolute value of convolution results. In an exemplary embodiment of the present invention, the maximum of four absolute convolution results are chosen for each pixel. The structure detection results may be achieved with a thresholding operation. The threshold may be chosen empirically, but could be decided automatically once the signal noise ratio is estimated. The structure detection result may be binary. A smoothed version can be created with a continuous transfer function instead of simple thresholding.

FIG. 2 shows a block diagram illustrating a method of structure detection, according to an exemplary embodiment of the present invention. For the first kernel which orients at θ=0 degrees, set the intensity of pixels within the black region to 1, and set the value to 0 for the rest of the pixels. The width and length of the black bar may favor the structure of interest. For example, the width × length of the black bar may be 13×5 pixels. The input image can be an image or image difference. For less memory usage and reduced computation, the convolution results may be measured for each frame. The convolution results of image differences can be acquired by subtraction of convolution results of corresponding frames.

In a method of reducing noise in an image sequence, according to an exemplary embodiment of the present invention described in connection with FIG. 1, after detecting structures in an image sequence, in step 120, estimate lighting changes in the image sequence and compensate for the estimated lighting changes. For example, estimating lighting changes in the image sequence may comprise calculating image differences on consecutive frames. According to an exemplary embodiment of the present invention, estimating lighting changes in the image sequence and compensating for the estimated lighting changes comprises calculating image differences on consecutive frames, and compensating for differences caused by the moving structures in the image sequence.

In step 130, detect moving structures in the image sequence using the detected structures after compensating for the estimated lighting changes in the image sequence. For example, detecting moving structures in the image sequence may be based on image differences after compensating for the estimated lighting changes in the image sequence.

In step 140, imaging noise in the image sequence is adaptively filtered based on the moving structure detection. For example, by utilizing the moving structures detection result, the image sequence may be adaptively filtered to increase the signal noise ratio while preserving the structures of interest. The adaptive filtering may be used to reduce the imaging noise on every image frame, including both static and outlier regions, in the image sequence. In an exemplary embodiment of the present invention, the imaging noise in static regions and moving regions are filtered differently. For outlier regions, wherein the pixel correspondence between frames cannot be easily established, an accurate estimate the motion vector for each pixel can be utilized. In an exemplary embodiment of the present invention, detection of the moving regions includes finding the regions where motion is not zero, and using spatial filtering to reduce the imaging noise. The spatial filtering may rely on pixels on the same frame instead of corresponding pixels between frames. Filtering will be described later in this disclosure.

There are several mechanisms that cause temporal changes along the X-ray sequence, such as for example, motion, lighting change and noise. To detect outliers more accurately, according to an exemplary embodiment of the present invention, lighting change are estimated and then excluded from temporal image difference.

Lighting estimation may be measured with image differences. The image differences include lighting change, motion and noise. For the purposes of this disclosure, detection of the significant change that is likely due to motion is referred to as “loose outlier” detection.

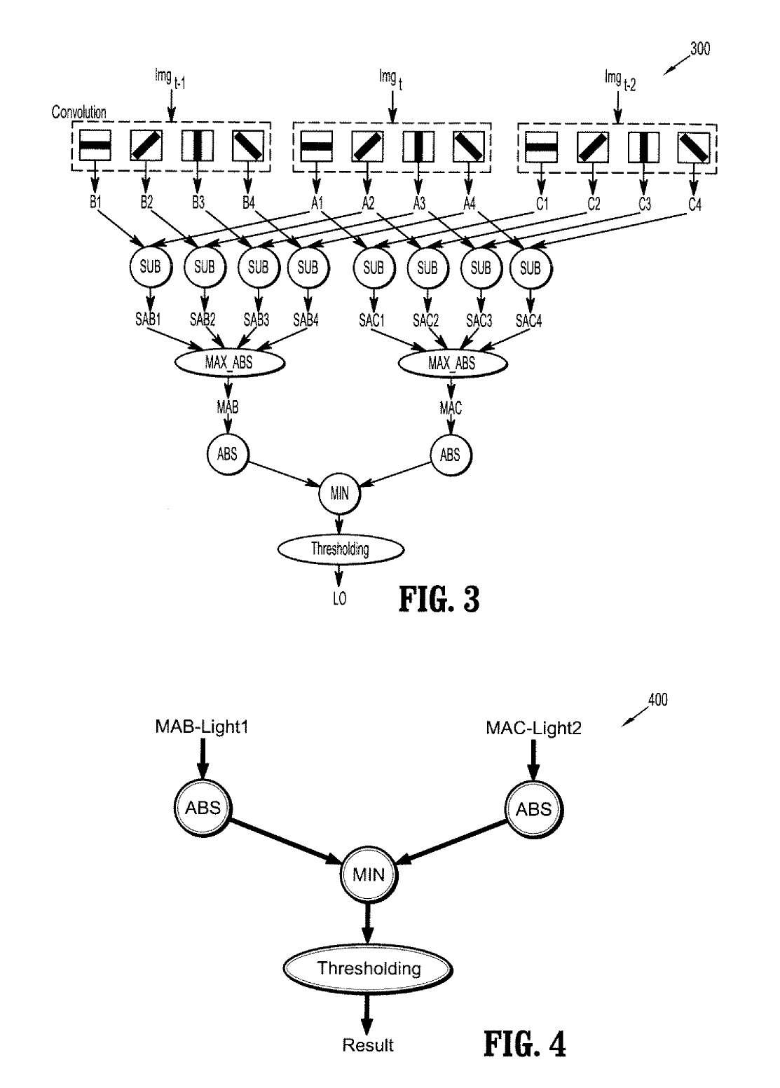

FIG. 3 shows a block diagram illustrating a method of loose outlier detection, according to an exemplary embodiment of the present invention. The loose outlier detection is based on two image differences with the procedure shown in FIG. 3. The circles labeled “SUB” in FIG. 3 denote image subtraction. As described above with regard to structure detection, the convolution results (A1, A2, A3, A4) are computed in four directions when the frame at time t is available. On the other hand, the convolution results (B1, B2, B3, B4) for the frame at time t−1 and those (C1, C2, C3, C4) for the frame at time t−2 may be saved. The images A1 through A4 are subtracted by B1 through B4, respectively, and the differences are called SAB1 through SAB4. SAC1 through SAC4 are generated by subtracting C1 through C4 from A1 through A4. The above-described procedure yields two series of image groups, that is, SAB1 through SAB4 (group 1) and SAC1 through SAC4 (group 2). For group 1, compare the intensity pixel by pixel for the four images and find out the intensity with the largest absolute value for each pixel. The operation is called MAX_ABS and the image created is MAB. For group 2, perform MAX_ABS and obtain image MAC. Then, conduct thresholding for the minimum of the absolute values of MAB and those of MAC pixel by pixel and output the binary result image LO, where a result of 0 represents outlier. The threshold in loose outlier detection may be higher than the one used in outlier detection.

After the completion of loose outlier detection, the loose outliers are excluded from both of the image differences, which are denoted by Dif1 and DiF2, where Dif1=Imgₜ−Imgₜ₋₁ and Dif2=Imgₜ−Imgₜ₋₂. The image differences with loose outliers excluded are denoted by Dif1* and Dif2*, as follows: Dif1*=Dif1 dotproduct LO and Dif2*=Dif2 dotproduct LO.

In an exemplary embodiment of the present invention, an averaging kernel with a size of 129×129 pixels is employed to filter Dif1* and Dif2*. It is to be understood that averaging kernels of various sizes may be employed to filter Dif1* and Dif2*. For example, to capture slower variations, an averaging kernel with a large size may be employed to filter Dif1* and Dif2*.

To speed up computation, integral images may be used for averaging. This allows the computation of averaging with a small, constant number of additions/subtractions per pixel and may yield a significant increase in speed. Due to loose outlier exclusion, the averaging result may be normalized, and then divided by the number of pixels included in the corresponding 129×129 window. Two lighting estimation images Light1 and Light2 may be employed. For example, Light1 represents the lighting changes pixel by pixel between the frames at times t and t−1, and Light2 represents the lighting changes between frames at times t and t−2. For example, Light1=Norm (Dif1* * AvgKernel) and Light2=Norm (Dif2* * AvgKernel), where * denotes convolution.

For outlier detection and temporal filtering, pixels in the current image Imgₜ, at time t may be divided into two groups: static group and outlier group. The static group represents the pixels that are not moving in the sequence, while the outlier group contains the pixels that belong to the moving structures.

For the static group, apply the frequency decomposition, which separates the image into a low-frequency component and a high-frequency component. The low-frequency component is kept during temporal filtering, while the high-frequency component at time t averages with the one at time t−1 or t−2, whichever is closer. To avoid the negative effect of structure blurring due to the decomposition under some circumstances, the structure detection and replacement can be used before the decomposition procedure. For the outlier group, the steps are simpler. Spatial filtering with a small kernel is implemented to keep the signal noise ratio aligned with the one in the static group.

Outlier detection is similar to loose outlier detection except that lighting changes are compensated and a stricter threshold is chosen. FIG. 4 shows a block diagram illustrating a method of outlier detection, according to an exemplary embodiment of the present invention.

As shown in FIG. 4, once convolution results are obtained out of the two image differences Dif1 and Dif2, the value of the result that has the biggest absolute value pixel by pixel is recorded, which produces two recorded image as MAB and MAC in FIG. 3. The corresponding lighting estimation images are subtracted from the recorded images. A pixel-by-pixel comparison is made of the absolute value of MAB−Light1 and that of MAC−Light2. For each pixel, the smaller value is used for thresholding. The result can be binary. The result can be a map to multi-value using a lookup table.

Frequency decomposition helps to reduce the light change effect, and will be discussed later in this disclosure. Since the line-shape structures and their neighbor pixels can counteract each other, the contrast of the structure may be blurred after temporal filtering. The removal of line structure before decomposition, according to an exemplary embodiment of the present invention, includes the following two steps. First, detect the line structure. This can be done by comparison between the MAX_ABS result of four directional convolutions for the current image and mean value within local window. The pixel is regarded as line structure if the difference is large enough. The second step is to replace each line structure pixel with its local mean value. Then low-pass filter is applied to obtain the low-frequency component based on the replaced image.

As mentioned above, temporal lighting changes exist along some frames. For pixels in static group, temporal filtering results will be affected by lighting change. But spatial filtering is used for outlier group, which is only related to current frame. This different treatment makes these two groups have different light conditions. A solution is to separate every frame into a low-frequency component and a high-frequency component, where Imgₜ(x,y)=ImgLowₜ(x,y)+ImgHighₜ(x,y). According to an exemplary embodiment of the present invention, temporal filtering is applied on the high frequency component, while the current low frequency component is not filtered. Lighting information may mainly exist in the low frequency component, and light change may not be involved in temporal filtering.

The static region and outlier region may have different characters, and may be treated differently. For a pixel at (x,y), regarded as static,
Imgₜ(x,y)=ImgLowₜ(x,y)+weight×ImgHighₜ(x,y) +(1−weight)×closer (ImgHighₜ₋₁(x,y), ImgHighₜ₋₂(x,y)),
where Imgₜ(x,y) is the filtered image at time t.

For an outlier pixel at (x,y), Imgₜ(x,y) can be expressed as follows.
Imgₜ(x,y)=0.5×Imgₜ(x,y)+0.125×Imgₜ(x−1,y)+0.125×Imgₜ(x+1,y) +0.125×Imgₜ(x,y−1)+0.125×Imgₜ(x,y+1).
The spatial filtering, in accordance with an exemplary embodiment of the present invention, enables the signal noise ratio of filtering results for pixels regarded as outliers to be consistent with that for static pixels.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

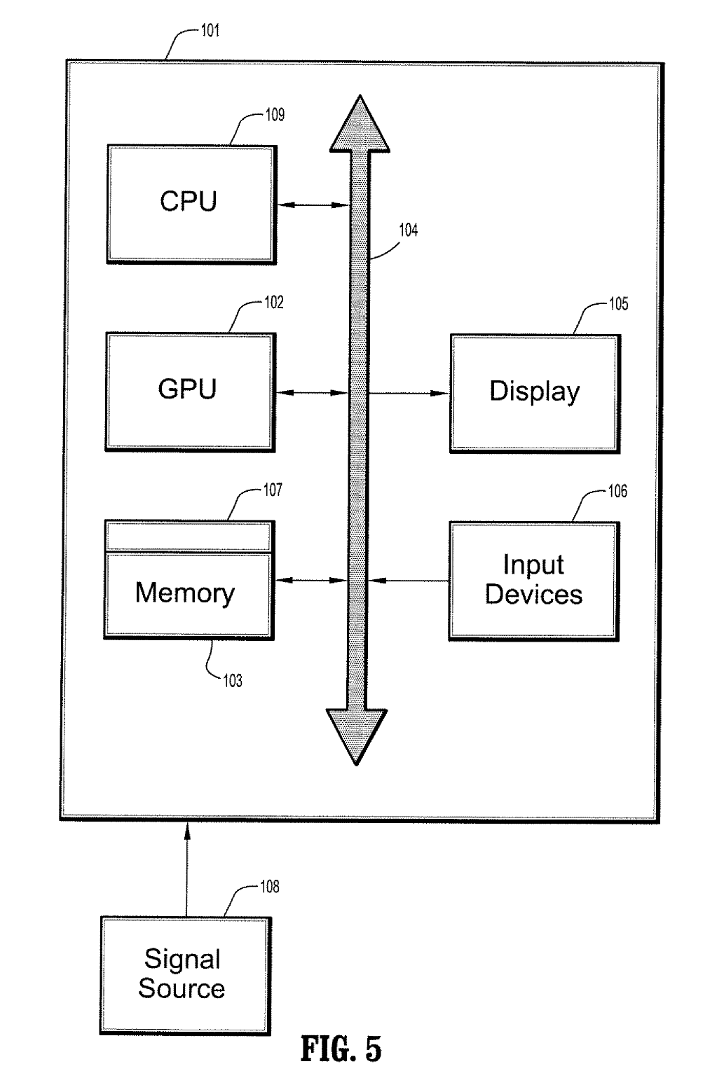

Referring to FIG. 5, according to an embodiment of the present disclosure, a computer system 101 for implementing a method of reducing noise in an image sequence can comprise, inter alia, a central processing unit (CPU) 109, a memory 103 and an input/output (I/O) interface 104. The computer system 101 is generally coupled through the I/O interface 104 to a display 105 and various input devices 106 such as a mouse and keyboard. The support circuits can include circuits such as cache, power supplies, clock circuits, and a communications bus. The memory 103 can include random access memory (RAM), read only memory (ROM), disk drive, tape drive, etc., or a combination thereof. The present invention can be implemented as a routine 107 that is stored in memory 103 and executed by the CPU 109 to process the signal from the signal source 108. As such, the computer system 101 is a general purpose computer system that becomes a specific purpose computer system when executing the routine 107 of the present invention.

The computer platform 101 also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

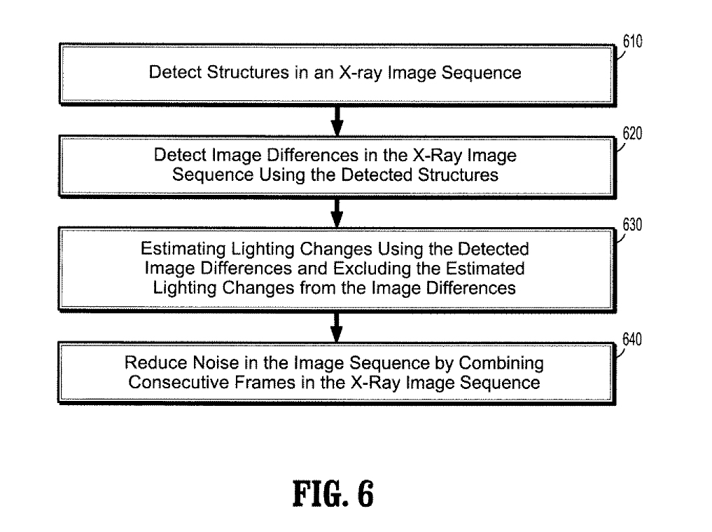

FIG. 6 is a flowchart showing a method of adaptively filtering an X-ray image sequence, according to an exemplary embodiment of the present invention. Referring to FIG. 6, in step 610, detect structures in an image sequence. For example, detecting structures in the image sequence may comprise performing feature detection and classification. Detecting structures in the image sequence may comprise using thresholding. The structure detection result may be binary. A smoothed version can be created with a continuous transfer function instead of simple thresholding.

In step 620, detect image differences in the X-ray image sequence using the detected structures. Image differences include lighting change, motion and noise. Detecting image differences in the X-ray image sequence may comprise excluding the moving structure part.

In step 630, estimate lighting changes using the detected image differences and exclude the estimated lighting changes from the image differences.

In step 640, reduce noise in the image sequence by combining consecutive frames in the X-ray image sequence.

Hereinafter, a computer readable medium including computer code for adaptively filtering an X-ray image sequence will be described. The computer readable medium comprise: computer code for detecting structures in an X-ray image sequence; computer code detecting image differences in the X-ray image sequence using the detected structures; computer code for estimating lighting changes using the detected image differences and excluding the estimated lighting changes from the image differences; and computer code for reducing noise in the image sequence by combining consecutive frames in the X-ray image sequence.

Although the exemplary embodiments of the present invention have been described in detail with reference to the accompanying drawings for the purpose of illustration, it is to be understood that the inventive processes and apparatus should not be construed as limited thereby. It will be readily apparent to those of reasonable skill in the art that various modifications to the foregoing exemplary embodiments may be made without departing from the scope of the invention as defined by the appended claims, with equivalents of the claims to be included therein.

What is claimed is:

1. A method of reducing noise in an image sequence, comprising:
detecting structures in an image sequence;
estimating lighting changes in the image sequence and compensating for the estimated lighting changes;
detecting moving structures in the image sequence using the detected structures after compensating for the estimated lighting changes in the image sequence; and
adaptively filtering imaging noise in the image sequence.

2. The method of claim 1, wherein detecting structures in the image sequence comprises performing feature detection and classification.

3. The method of claim 1, wherein estimating lighting changes in the image sequence comprises calculating image differences on consecutive frames.

4. The method of claim 1, wherein estimating lighting changes in the image sequence and compensating for the estimated lighting changes comprises:
calculating image differences on consecutive frames; and
compensating for differences caused by the moving structures in the image sequence.

5. The method of claim 1, wherein detecting moving structures in the image sequence is based on image differences after compensating for the estimated lighting changes in the image sequence.

6. The method of claim 1, wherein adaptively filtering comprises thresholding based on image differences in the image sequence.

7. The method of claim 6, wherein adaptively filtering further comprises image decomposition to decompose the image sequence into lighting images and detailed images.

8. The method of claim 7, wherein adaptively filtering further comprises combining consecutive frames of the detailed images to reduce noise in the image sequence.

9. The method of claim 1, wherein adaptively filtering comprises using a switching model to generate noise reduction while preserving the moving structures.

10. A system for reducing noise in an image sequence, comprising:
a memory device for storing a program;
a processor in communication with the memory device, the processor operative with the program to:
detect structures in an image sequence;
estimate lighting changes in the image sequence and compensate for the estimated lighting changes;
detect moving structures in the image sequence using the detected structures after compensating for the estimated lighting changes in the image sequence; and
adaptively filter imaging noise in the image sequence.

11. The system of claim 10, wherein when detecting structures in the image sequence, the processor is further operative with the program to perform feature detection and classification.

12. The system of claim 10, wherein when estimating lighting changes in the image sequence, the processor is further operative with the program to calculate image differences on consecutive frames.

13. The system of claim 10, wherein when adaptively filtering imaging noise, the processor is further operative with the program to perform thresholding based on image differences in the image sequence.

14. The system of claim 13, wherein when adaptively filtering imaging noise, the processor is further operative with the program to decompose the image sequence into lighting images and detailed images.

15. The system of claim 14, wherein when adaptively filtering imaging noise, the processor is further operative with the program to combine consecutive frames of the detailed images to reduce noise in the image sequence.

16. A method of adaptively filtering an X-ray image sequence, comprising:
detecting structures in an X-ray image sequence;
detecting image differences in the X-ray image sequence using the detected structures;
estimating lighting changes using the detected image differences and excluding the estimated lighting changes from the image differences; and
reducing noise in the image sequence by combining consecutive frames in the X-ray image sequence.

17. The method of claim 16, wherein detecting structures in an X-ray image sequence comprises using thresholding.

18. The method of claim 16, wherein detecting image differences in the X-ray image sequence comprises excluding the moving structure part.

19. A computer readable medium having program instructions stored thereto for implementing the method claimed in claim 16 when executed in a digital processing device.
